(19) United States
(12) Patent Application Publication
(10) Pub. No.: US 2019/0048633 A1
(43) Pub. Date: Feb. 14, 2019

(54) TWO-WAY DOOR SYSTEMS AND METHODS

(71) Applicant: JOSEPH R. RAUTH, NEW HAVEN, MO (US)

(72) Inventor: JOSEPH R. RAUTH, NEW HAVEN, MO (US)

(21) Appl. No.: 15/673,008

(22) Filed: Aug. 9, 2017

(51) Int. Cl. E05D 7/02; E05D 7/081; E05D 11/06

(52) U.S. Cl. CPC E05D 7/02; E05D 7/081; F25D 2323/024; E05Y 2900/31; E05D 11/06

(57) ABSTRACT

Systems and methods for implementing a bi-directional, or two-way door which can be opened from either the left or right side using, in one embodiment, a transfer bar connected to a pair of hinge pins so as to cause each pair to alternatingly insert into or retreat from receivers in a door frame on opposing sides. In a second embodiment, a pair of wheels with offset camming surfaces alternatingly operate corresponding lifting elements to engage or disengage hinge pins on opposing sides of a door.

### BACKGROUND OF THE INVENTION

### Field of the Invention

This disclosure is related to the field of appliances. In particular, it relates to systems and methods for implementing a two-way door that can be opened from either side.

### Description of the Related Art

Traditionally, appliance doors, and other doors, open on one side via a hinged connection between the door and a mounting frame with a hand pull on the opposing side. When the user approaches the door, he or she grasps the pull (generally a doorknob) to move the unhinged side, and causes the door to pivot at the hinge.

However, there are many applications in which a bidirectional, or two-way, door is beneficial. In small living spaces, or in environments having multiple devices with doors, doors that open on only one side can present problems.

For example, if a refrigerator is designed only to open on the right hand side, then it may be difficult to use the refrigerator in a kitchen in which the refrigerator is located to the left side of the main work area. This arrangement would require the cook to walk past the refrigerator and open the door to the right, causing the door to block the path back to the work area. If the refrigerator door could be opened from either side, it would be suitable for use in any kitchen configuration. This would reduce the need to manufacture and stock refrigerators with doors that can open from one side, and would reduce the difficulty of the consumer trying to find a refrigerator that opens in the direction most convenient for that particular consumer's kitchen layout.

These issues are not limited to refrigerators. Appliances such as front loaded washers and dryers, for example, have utility hookups for gas and water, which may require that the appliances be disposed in a specific location. Similarly, electrical, gas, ventilation, and water hookups for other appliances may require that these appliances be disposed in a specific area in a kitchen. When remodeling, it would be beneficial for the consumer to have a choice of appliances that can be opened on either side, allowing for maximum versatility, and reducing manufacturing, shipping, and inventory costs by not having to supply mirror image door configurations for products.

Many solutions to implementing the two-way door have been proposed over the years, but none have been commercially successful due to various shortcomings. Prior art solutions tend to be too mechanically complex, resulting in breakage or wear over time until the mechanism no longer functions properly. Additionally, many prior art solutions require moving parts within the structure of the door panel. This causes problems because some appliances, such as refrigerators, require insulation within the door and the presence of moving mechanical parts inhibits the use of insulation, making the refrigerator less efficient. Similarly, for microwaves, the main panel of the door is generally clear, and cannot be obstructed by mechanical components.

Prior art FIG. 1 depicts a prior art appliance 101. In the depicted embodiment of FIG. 1, appliance 101 is a conventional refrigeration unit. The depicted refrigerator 101 comprises two openable doors 103 attached to the refrigerator 101 body via an attaching means or mechanism 105. In the depicted embodiment, the attaching mechanism 105 is a set of hinges attached to the door 103 and the refrigerator body via hardware screws. The use of a basic hinge 105 is among the most common ways of attaching a door 103 to an appliance 101, though it is more common to obscure the hinges 105 in the internal structure for aesthetic reasons. As can be seen in prior art FIGS. 1 and 2, the user typically operates the door by grasping a pull 102, which in the depicted embodiment is simply a fixed handle attached to the door. This is a very basic way of attaching a door 103, and obviously does not allow for two-way opening because the attaching mechanism 105 is permanently attached to both the door 103 and the refrigerator 101. This means that the door 103 can only be opened on the right hand side where the attaching mechanism 105 is attached.

Prior art FIG. 2 depicts an alternative embodiment of a refrigerator 101 in which the doors 103 are attached using a different attaching mechanism 105. In the depicted prior art embodiment of FIG. 2, the attaching mechanism 105 comprises a rigid bracket or brace 106 attached to the structure of the refrigerator 101. The brace 106 has a pair of pegs or pins 107 on opposing sides disposed vertically, and configured to correspond to openings or holes 109 in the top and bottom of the door 103. The doors 103 are seated on the pins 107 by inserting the pins 107 into the holes 109, and the doors 103 open by rotating around the pins 107. However, this alternative prior art embodiment also does not allow for two-way opening.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a system for opening a door from either side comprising: a door structure having a top side and an opposing bottom side, and a left side and an opposing right side; a transfer bar having a first end and an opposing second end; a first pair of hinge pins, each hinge pin in the first pair of hinge pins having a proximal end connected to the first end of the transfer bar and an opposing distal end, the distal end of a first hinge pin in the pair disposed at the top side and the distal end of a second hinge pin in the pair disposed at the bottom side; a second pair of hinge pins, each hinge pin in the second pair of hinge pins having a proximal end connected to the second end of the transfer bar and an opposing distal end, the distal end of a first hinge pin in the second pair disposed at the top side and the distal end of a second hinge pin in the second pair disposed at the bottom side; wherein when the transfer bar moves laterally toward the left side, the transfer bar causes the distal ends of the first pair of hinge pins to protrude outward from the top and bottom sides of the door, and the distal ends of the second pair of hinge pins to retreat within the door structure.

In an embodiment of the system, each hinge pin in the first pair and second pair of hinge pins is connected to the transfer bar via a U-link rotatably connected to the proximal ends and rotatably connected to the transfer bar.

In another embodiment of the system, the transfer bar and the hinge pins are disposed within the interior structure of the door structure.

In still another embodiment of the system, the transfer bar and the hinge pins are disposed on an exterior surface of the door structure.

In still another embodiment of the system, the door structure is attached to an appliance.

In still another embodiment of the system, the appliance comprises a utility connection line and the utility connection line is connected to the door structure through an umbilical extending from an interior side of the door to a compartment within the appliance, the umbilical configured such that when the door is opened to a maximum angle, the distal end of the umbilical remains in the compartment.

In still another embodiment of the system, when the transfer bar moves laterally toward the left side and causes the distal ends of the first pair of hinge pins to protrude outward from the top and bottom sides of the door, the distal ends of the hinge pins engage corresponding receivers in the appliance such that the door structure is rotatable on the first pair of hinge pins.

In still another embodiment of the system, the distal ends of each of the hinge pins in the first pair and the second pair are chamfered.

In still another embodiment of the system, when the transfer bar moves laterally toward the right side, the transfer bar causes the distal ends of the second pair of hinge pins to protrude outward from the top and bottom sides of the door, and the distal ends of the first pair of hinge pins to retreat within the door structure.

In still another embodiment of the system, the top hinge pin in the first pair and the top hinge pin in the second pair are disposed through a locking mechanism.

In still another embodiment of the system, each of said locking mechanisms comprises a movable latch configured to rotatably engage a corresponding circumferential notch in said each of said top hinge pins in said first pair and said second pair.

In still another embodiment of the system, the transfer bar is moved by manipulating hand pulls attached to the transfer bar.

In still another embodiment of the system, the transfer bar is moved by a motor attached to the transfer bar.

Also described herein, among other things, is a system for opening a door from either side comprising: an appliance comprising an appliance body and a door, the door having a top portion and an opposing bottom portion, and a left side and an opposing right side; a first top receiver disposed in the appliance body at the left side; a first through bore in the top portion axially aligned with the first top receiver when the door is closed; a second top receiver disposed in the appliance body at the right side; a second through bore in the top portion axially aligned with the second top receiver when the door is closed; a first through bore in the bottom portion axially aligned with the first through bore in the top portion; a second through bore in the bottom portion axially aligned with the second through bore in the top portion; a first wheel having a first camming portion disposed at a position thereon; a second wheel having a second camming portion disposed at a position thereon; a crossbar axially connecting the first wheel to the second wheel such that the crossbar, first wheel, and second wheel move in unison; a first lifting element between the first wheel and the bottom portion of the door, the first lifting element having a first bottom stationary hinge pin axially aligned with a first receiver in the bottom portion; a second lifting element between the second wheel and the bottom portion of the door, the second lifting element having a second bottom stationary hinge pin axially aligned with a second receiver in the bottom portion; a first hinge pin having a bottom end and an opposing top end and disposed through the first top bore and the first bottom bore such that the bottom end rests on the first lifting element; a second hinge pin having a bottom end and an opposing top end and disposed through the second top bore and the second bottom bore such that the bottom end rests on the second lifting element; wherein when the first wheel is rotated such that the first camming portion is generally coplanar with the bottom of the first lifting element: the first bottom stationary hinge pin retreats from the first bottom receiver and the top end of the first hinge pin retreats from the first top receiver; and the second camming surface is not adjacent to the second lifting surface such that the second lifting surface forms a tangent line to a rounded portion of the second wheel and the rounded portion of the second wheel lifts the second lifting element such that the second bottom stationary hinge pin engages the second bottom receiver and the top end of the second hinge pin engages the second top receiver such that the door is pivotable on an axis of rotation from the second top receiver to the second bottom receiver.

In an embodiment of the system, when the second wheel is rotated such that the second camming portion is generally coplanar with the bottom of the second lifting element: the second bottom stationary hinge pin retreats from the second bottom receiver and the top end of the second hinge pin retreats from the second top receiver; and the first camming surface is not adjacent to the first lifting surface such that the first lifting surface forms a tangent line to a rounded portion of the first wheel and the rounded portion of the first wheel lifts the first lifting element such that the first bottom stationary hinge pin engages the first bottom receiver and the top end of first hinge pin engages the first top receiver such that the door is pivotable on an axis of rotation from the first top receiver to the first bottom receiver.

In another embodiment of the system, the axis of rotation has an angle offset from an alignment normal to the pull of gravity.

In a still further embodiment of the system, the offset is configured so as to cause gravity to pull the door closed when the door is open at an angle of less than 90 degrees.

In a still further embodiment of the system, the offset is configured so as to cause gravity to pull the door open when the door is open at an angle of greater than 90 degrees.

In a still further embodiment of the system, the first hinge pin is spring-loaded against the bottom of the top portion, and the second hinge pin is spring-loaded against the bottom of the top portion.

In a still further embodiment of the system, the appliance comprises a utility connection line and the utility connection line is connected to the door through an umbilical extending from an interior side of the door to a compartment within the appliance, the umbilical configured such that when the door is opened to a maximum angle, the distal end of the umbilical remains in the compartment.

### BRIEF DESCRIPTION OF THE DRAWINGS

FIGS. 1 and 2 depict prior art appliances with one-way doors.

FIG. 3 is a perspective cutaway view of an embodiment of a two-way door according to the present disclosure, configured to hinge to the right and open to the left.

FIGS. 3A and 3B are detailed views of the embodiment of FIG. 3.

FIG. 4A depicts the embodiment of FIG. 3 configured to hinge to the left and open to the right, and placed in an appliance frame.

FIG. 4B depicts a perspective view of a hinge pin and a receiver including an adjustable seat.

FIG. 5 depicts a perspective view of an embodiment of a two-way door according to the present disclosure, configured to have a window in the center.

FIGS. 6A, 6B, and 6C depict perspective views of an alternative embodiment of a two-way door according to the present disclosure.

FIGS. 7A, 7B, and 7C depict a perspective view of a hinge pin locking system according to the present disclosure.

FIGS. 8A and 8B depict a perspective view of an alternative embodiment of a hinge pin locking system according to the present disclosure.

FIG. 9 depicts a perspective view of an umbilical system according to the present disclosure.

FIG. 10 depicts a perspective view of an alternative embodiment of a two-way door according to the present disclosure.

FIG. 11 depicts a schematic diagram of a motorized two-way door according to the present disclosure.

FIG. 12 depicts a reversed U-link configuration according to the present disclosure.

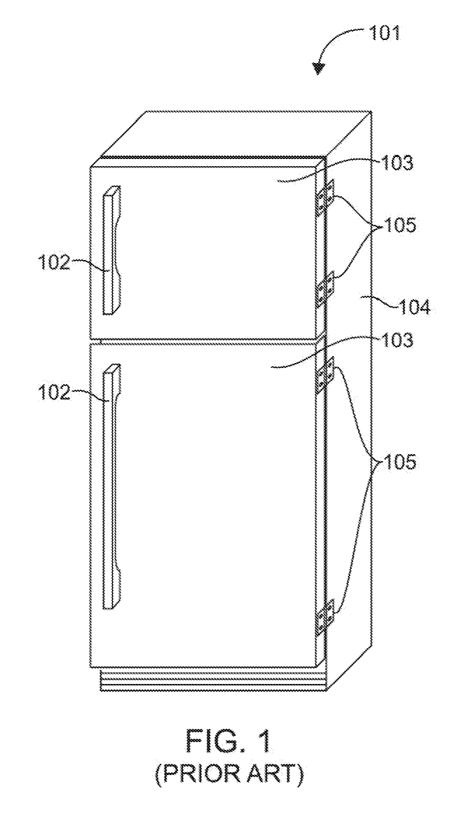

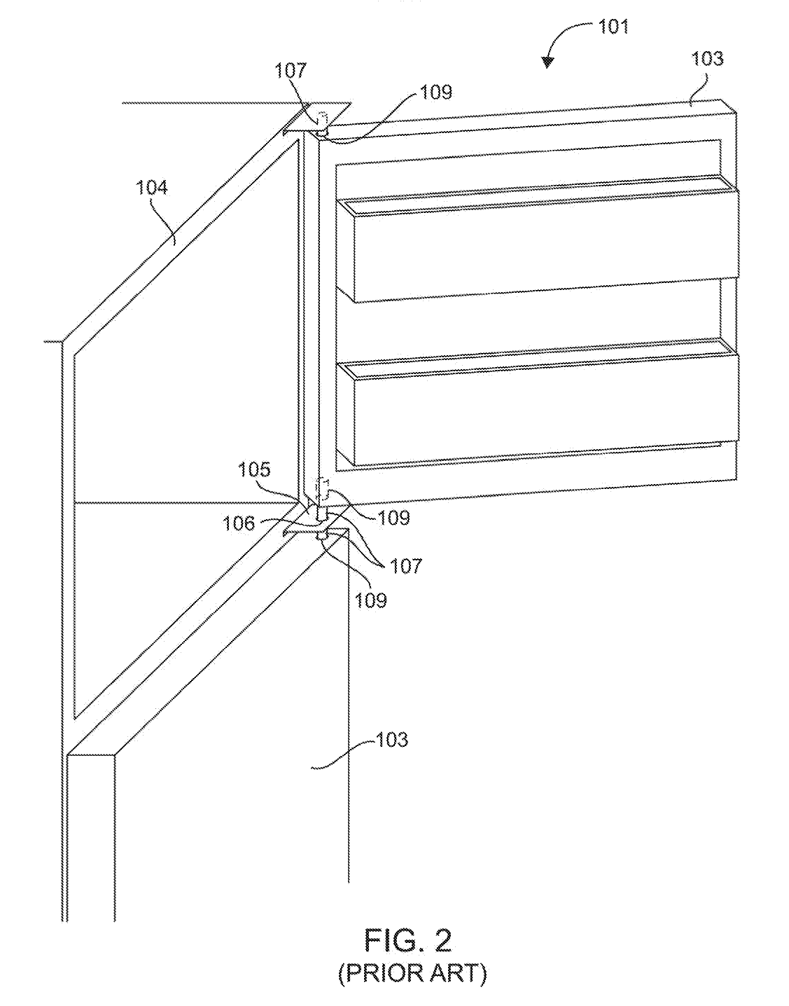

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein are systems and methods for implementing a bi-directional or two-way door, which can be opened from either the left or right side. Although the embodiments described herein are primarily with reference to appliances such as refrigerators and microwaves, the systems and methods are applicable to any door, and can be used in any embodiment, including, but not necessarily limited to, other appliances, and residential or commercial doors.

As will be clear to one of ordinary skill in the art, any bi-directional door must effectively accomplish two tasks. First, when the user operates the door, the apparatus must engage a structure at the opposing end of the door from the side operated by the user to provide for rotation. Second, the apparatus must disengage the rotational structure on the side grasped by the user so that the door can freely open.

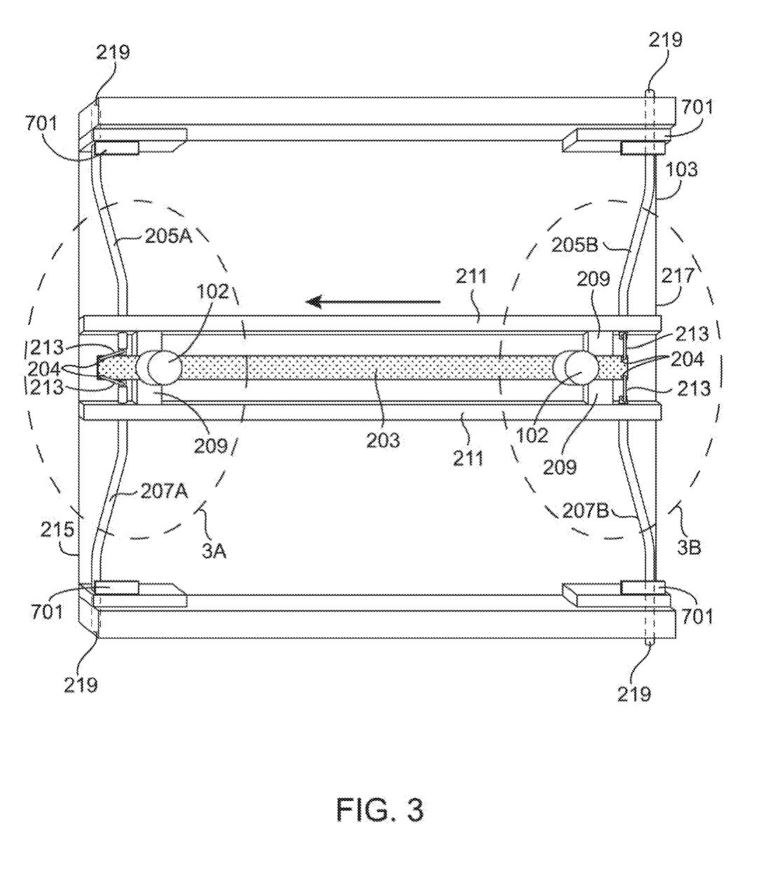

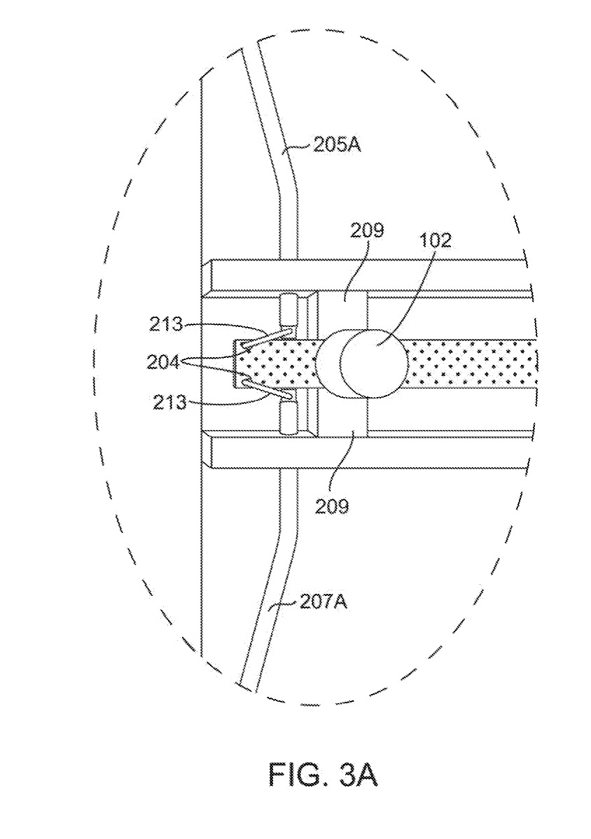

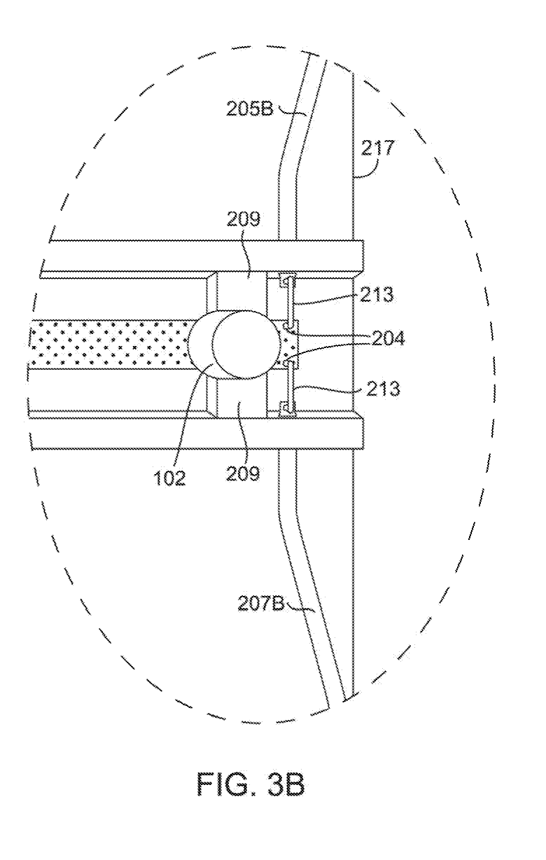

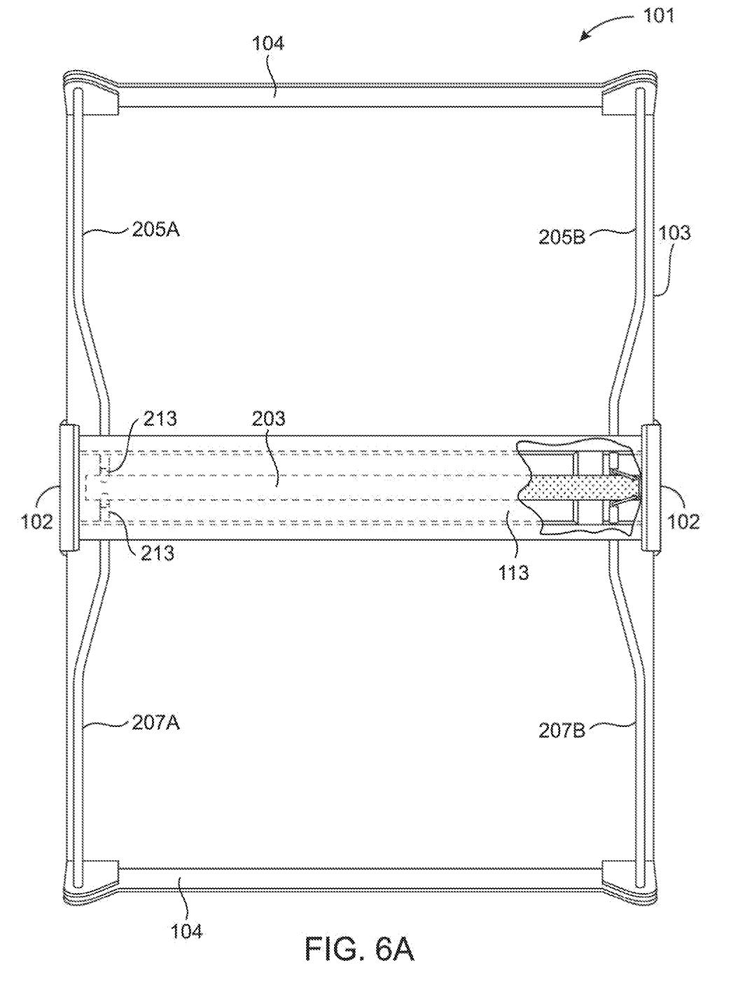

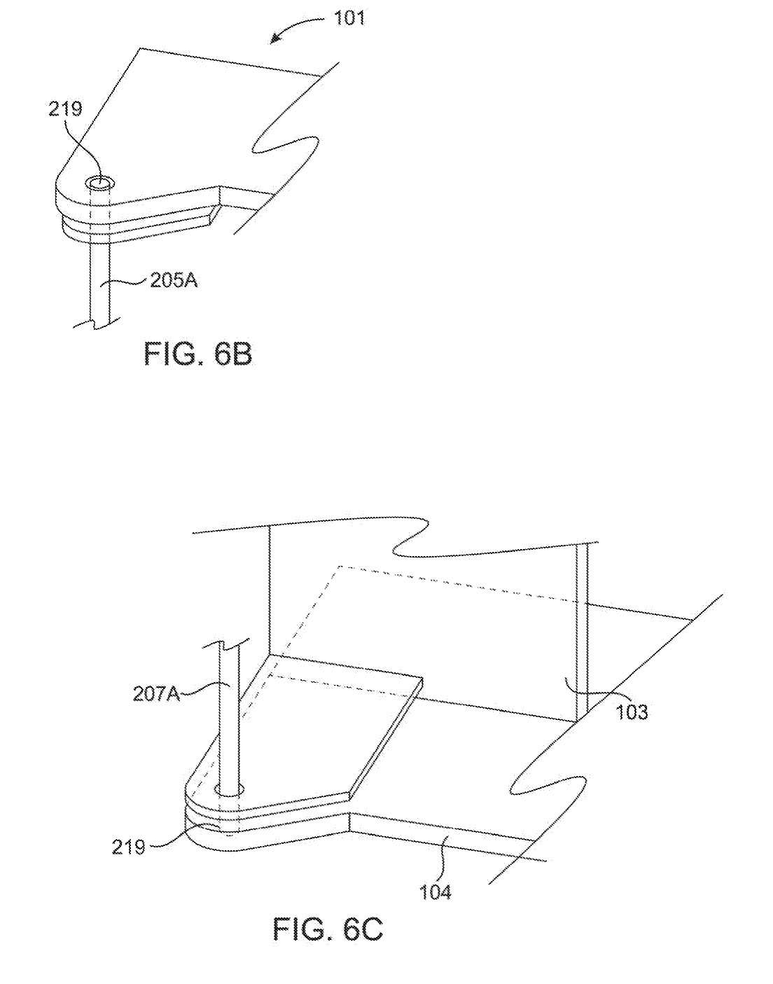

FIG. 3 depicts a basic embodiment of a system and method for implementing a two-way door according to the present disclosure. The depicted embodiment of FIG. 3 is a perspective cutaway view showing the major components and how they interact. The components depicted in FIG. 3 and described herein may be disposed within the structure of the door panel (as shown in FIG. 3), but may alternatively be disposed on the exterior of the door as described in more detail elsewhere herein (for example, in FIG. 6).

In the depicted embodiment of FIG. 3, an appliance door 103 contains certain mechanical elements interconnected in a fashion to implement a two-way door. The depicted embodiment includes a transfer bar 203. The depicted transfer bar 203 is an elongated element generally in the configuration of a rectangular prism having one, two, or more openings 204 on the opposing ends thereof but other shapes and configurations are possible to achieve the transfer bar's 203 functions. The openings 204 in the depicted transfer bar 203 are sized and shaped to accept one leg of a U-link 213. The transfer bar 203 transfers the mechanical motion of opening laterally from one side of the door 103 to the other, as described in further detail herein.

In the depicted embodiment, guides 209 are disposed adjacent to the transfer bar 203 to maintain a consistent position vertically within the structure of the door 103. The depicted guides 209 are blocks of material disposed on the top and bottom sides of the transfer bar 203 at the opposing ends of the transfer bar 203. Other shapes, quantities, and positions are possible. In the depicted embodiment, two bracing structures 211, which are also in the configuration of elongated rectangular prisms, extend from one side 215 of the door 103 to the other 217, and are disposed generally parallel to one another. These bracing structures provide a mounting point for the guides 209. However, it is not necessary for these brace structures 211 to extend to the edge of the door 103 and the exact configuration of these bracing structures 211 will vary from embodiment to embodiment. The depicted transfer bar 203 is disposed generally parallel to, and between, the depicted bracing elements 211. The depicted guides 209 are each disposed between one bracing element 211 and the transfer bar 203, causing the transfer bar 203 to be able to move laterally (from left to right and vice versa) within the structure of the door 103.

The depicted transfer bar 203 is attached at each of its opposing ends to four hinge pins 205A, 205B, 207A, 207B. The depicted hinge pins 205A, 205B, 207A, 207B are generally in the configuration of an elongated cylindrical element with a bend in the middle. The depicted hinge pins 205A, 205B, 207A, 207B are configured to attach to the transfer bar 203 at one end and to hinge/unhinge the door 103 at the opposing end.

The depicted embodiment of FIG. 3 comprises four hinge pins 205A, 205B, 207A, 207B mechanically arranged into two sets. The depicted hinge pins 205A and 205B are disposed on the top or upward portion of the door 103, and hinge pins 207A and 207B are disposed on the bottom or lower portion of the door 103. It will be understood that “top and bottom”, or “up and down”, are interpreted with respect to the direction of gravity, as the force of gravity is used to operate lower pins 207A and 207B, and is overcome to operate upper pins 205A and 205B. One of ordinary skill will further understand that “upper hinge pins” refers to 205A and/or 205B together or individually, and “lower hinge pins” refers to hinge pins 207A and/or 207B, together or separately. Additionally, it will be further understood that the hinge pins on each of the opposing sides 215 and 217 of the door 103 operate together. That is, upper hinge pin 205A and lower hinge pin 207A operate together to hinge or unhinge the door 103 on the left side 215. Likewise, upper hinge pin 205B and lower hinge pin 207B operate together to hinge or unhinge the door 103 on the right side 217. Also, the term “left hinge pins” refers to hinge pins 205A and 207A, and the term “right hinge pins” refers to hinge pins 205B and 207B.

Each of the hinge pins 205A, 205B, 207A, 207B is connected to the transfer bar 203 by a U-link 213. In the depicted embodiment of FIG. 3, the proximal end of each hinge pin 205A, 205B, 207A, 207B (proximal to the transfer bar 203) comprises a bore through which a leg of the U-link 213 is inserted and the other leg of the U-link 213 is inserted into a corresponding bore 204 in the transfer bar 203. Thus, the transfer bar 203 is attached to each of the four hinge pins 205A, 205B, 207A, 207B by a U-link 213.

As can be seen in FIG. 3, when transfer bar 203 is moved, the transfer bar 203 causes the U-links 213 to exert pushing or pulling forces on the attached hinge pins 205A, 205B, 207A, 207B. Depending on the lateral position of the transfer bar 203, the direction of the force exerted on the hinge pins 205A, 205B, 207A, 207B by the transfer bar 203 changes. In the depicted embodiment of FIG. 3, for example, the transfer bar 203 has been moved to the left side 217, causing the right side U-links 213 to straighten, which in turn exerts a vertical upward force on hinge pin 205B, and vertical downward force on hinge pin 207B. This in turn causes the distal end of hinge pin 207B to protrude through the bottom of the door 103, and engage a corresponding receiver, such as a hole or bore in the appliance structure (not pictured in FIG. 3). This creates a rotation point at the distal end 219 of hinge pin 207B. On the other side 215 of the door 103, the movement to the left of the transfer bar 203 pulls the U-links 213 towards the vertical center line of the door 103. This in turn exerts pulling force on hinge pins 205A and 207A, pulling them towards the center line of the door 103 and causing them to swedge against the transfer bar 203. For bottom hinge pin 207A, this causes the distal end 219 to retreat from the receiver into the door 103 so that the door 103 can open on the left hand side 215.

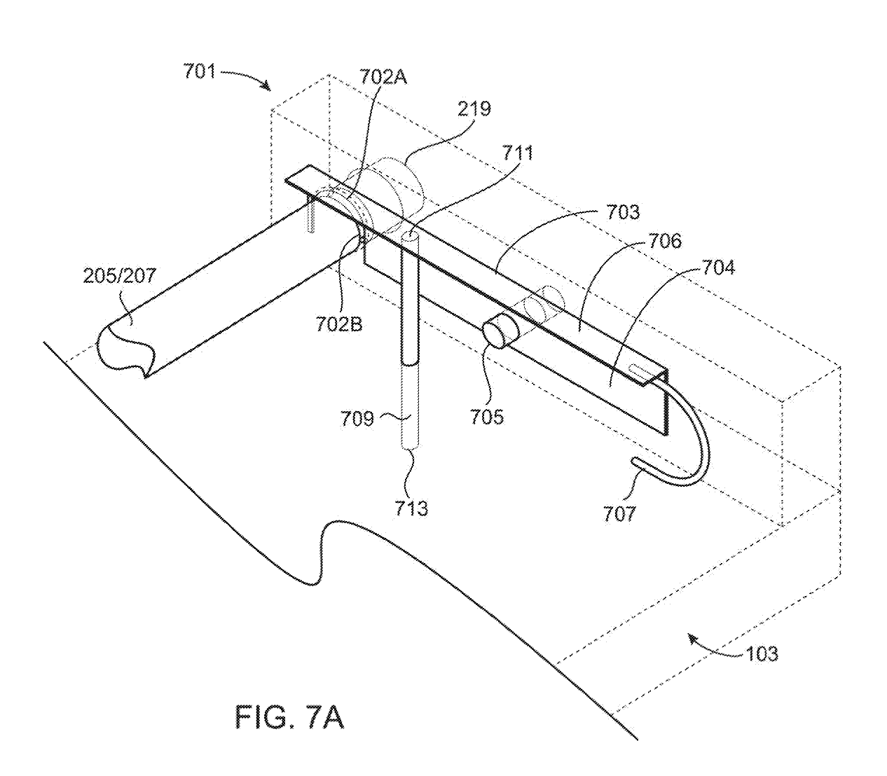

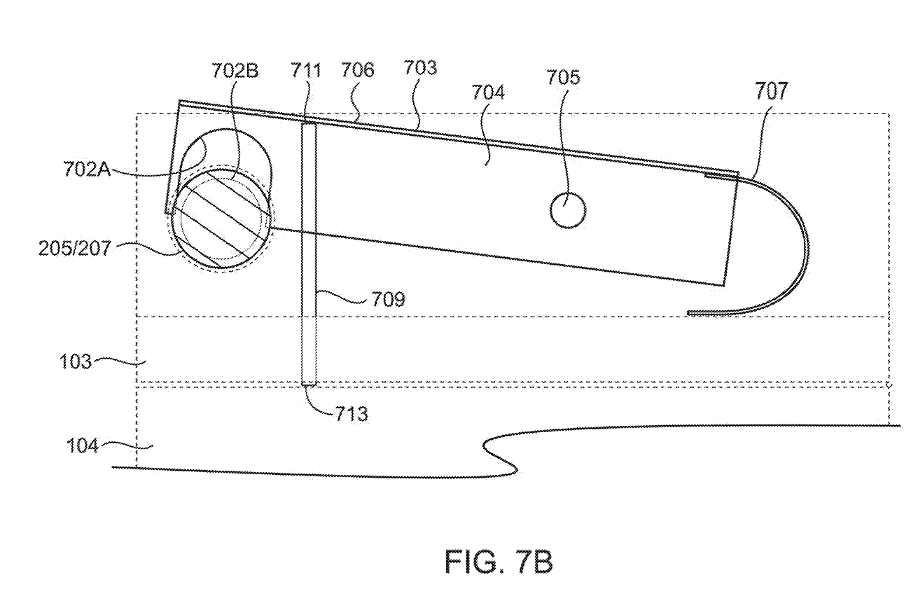

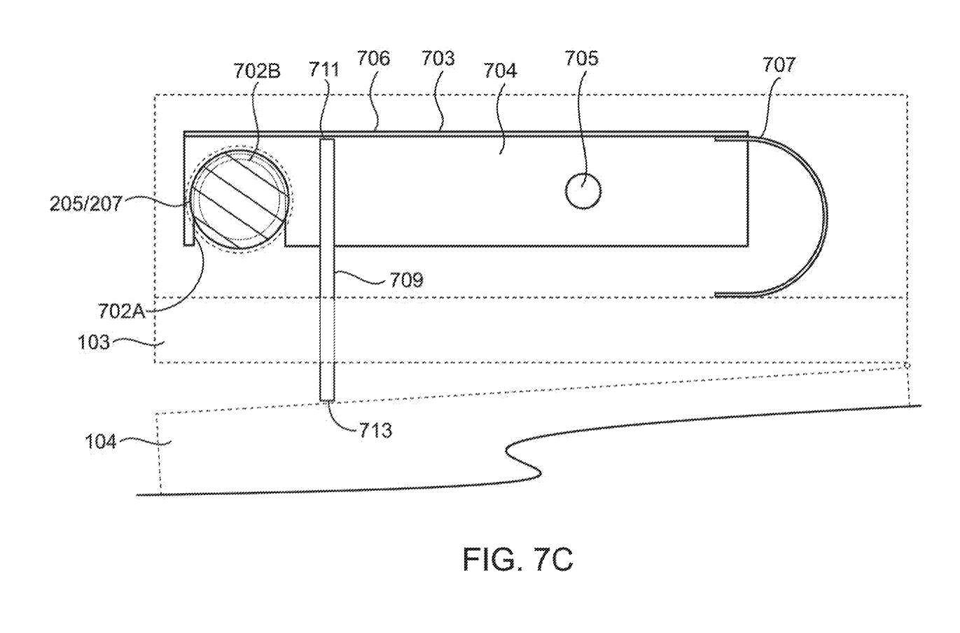

On the top side of the door, the movement left of the transfer bar 203 causes the U-link 213 to exert pushing force on hinge pin 205B upward through a locking mechanism 701 described in more detail elsewhere herein, in particular with respect to FIGS. 7A, 7B, and 7C. It should be noted that although FIG. 3 depicts a locking mechanism for all four depicted hinge pins, this is not necessary and in the preferred embodiment, the locking mechanism is used only on one or both of the top hinge pins 205A and 205B.

The distal end 219 of hinge pin 205B protrudes through the top of the door 103 to engage a receiver in the appliance structure (not depicted), completing the rotational connection. That is, hinge pins 205B and 207B both engage with corresponding top and bottom receivers in the appliance 101 structure, establishing a pivot point on the right side 217. By contrast, the movement to the left of the transfer bar 203 pulls hinge pins 205A and 207A inward, retracting the distal ends 219 of each 205A and 207A such that the distal ends 219 are within the door 103 and do not inhibit door 103 operation. This allows the door 103 to be opened on the left hand side 215.

In the depicted embodiment of FIG. 3, the operation of the transfer bar 203 to the left or right is facilitated by a pull 102. In the depicted embodiment of FIG. 3, the pulls 102 on each side are rigidly attached to the transfer bar 203 through the door 103 surface (not shown). The user operates the door 103 by sliding the pulls 102 to the left or right, which imparts motion to the transfer bar 203, which operates the two-way mechanics described herein.

In the depicted embodiment of FIG. 3, each of the hinge pins 205A, 205B, 207A, 207B is connected to the transfer bar 203 through an aperture in bracing elements 211. This allows the hinge pins 205A, 205B, 207A, 207B to maintain consistent vertical alignment and minimize lateral movement of the hinge pins 205A, 205B, 207A, 207B within the door 103. Similarly, guides 209 inhibit vertical movement of transfer bar 203.

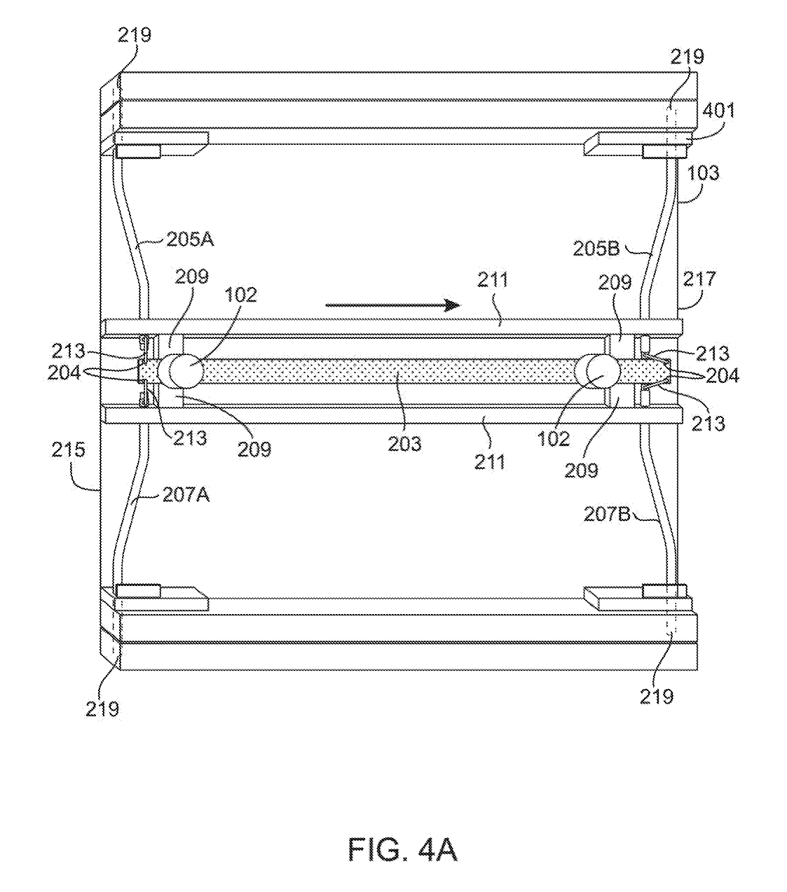

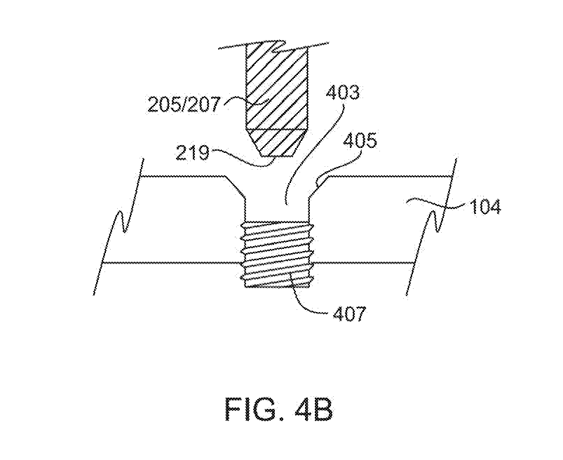

FIG. 4 depicts the same embodiment of FIG. 3 in reverse operation. In the depicted embodiment of FIG. 4, a user has grasped the pull 102 and operated the pull 102 to slide the transfer bar 203 to the right. This in turn causes the left hand U-links 213 to exert vertical force on hinge pins 205A and 207A, which in turn causes them to move vertically (upward for 205A and downward for 207A) until the distal ends 219 protrude from the top and bottom of the door 103 and engage in corresponding receivers in the appliance structure (not depicted). Likewise, this motion exerts pulling force on the right hand U-links 213, drawing hinge pins 205B and 207B inward toward the vertical center of the door, retracting their distal ends 219 into door 103 and retreating from receivers in the appliance structure. Thus, the hinge pins 205A and 207A on the left hand side engage, and the hinge pins 205B and 207B on the right hand side disengage, and the door 103 can be opened by pivoting on the left hand side. This operation can then be reversed again to put the door 103 back into the configuration of FIG. 3.

The mechanical components depicted in FIGS. 3 and 4 can be enclosed within the door 103 structure. In a refrigerator, the door interior may further include insulating material to increase the thermal retention characteristics of the appliance. The bracing elements 211 both provide movement guides for the hinge pins, as well as separate the lateral movement components of the transfer bar from the rest of the door structure. This also allows insulating material to be inserted or placed throughout most of the interior door structure.

An advantage of this configuration is that no springs are required for the hinge pins to attach and detach. This increases the life span of the apparatus, because springs tend to lose elasticity over time, resulting in electrical failure in the hinging mechanism. Because the mechanism described herein does not require the use of springs, it may be used indefinitely.

The means for building the embodiments described herein will be readily apparent to one of ordinary skill in the art. In particular, it is notable that the transfer bar is effectively the load bearing apparatus in the door 103. Because the door 103 is attached to the appliance 101 body via the hinge pins, which in turn are connected via the transfer bar 203, the transfer bar 203 effectively bears the full weight of the door 103. Therefore, materials with resilient characteristics are desirable to allow the door 103 to carry the weight of other items.

In the depicted embodiments of FIGS. 3 and 4, the distal ends 219 of the hinge pins 205A, 205B, 207A, 207B are tapered or chamfered. In an embodiment, the receivers include an adjustable seat or bushing to engage the hinge pins and facilitate proper carriage of the door 103 without the bottom of the door 103 rubbing against the appliance frame. This also provides a margin of error to accommodate wear, manufacturing tolerances, thermal expansion, and other expected, minor variations in alignment. By chamfering the ends 219, an exact axial alignment between the receivers and the hinge pins is not necessary, because the chamfered surface will self-align the hinge pins in the receivers to establish proper seating.

FIG. 4B depicts a detailed view of the interaction between the distal end 219 of a hinge pin 205 and 207 with a receiver 403. The depicted receiver 403 is a bore in the appliance frame 104. The depicted bore 403 has a chamfered 405 first end to receive the distal end 219 of the hinge pin, and a seat element 407 disposed at an opposing end of the bore 403. The seat element is preferably an adjustable element such that the depth of the seat in the bore 403 is adjustable. For example, in the depicted embodiment, the seat 407 is a threaded element that can be rotated to progress the seat 407 into, or retract it from, the receiver 403. When the distal end 219 is inserted into the receiver 403, the chamfered distal end 219 and chamfered 405 first end of the receiver 403 cooperate to engage the hinge pin in the receiver 403 until the distal end 219 contacts the top of the seat 407. The hinge pin rotates at this contact point. The seat 407 is adjustable and/or replaceable for servicing over time due to wear.

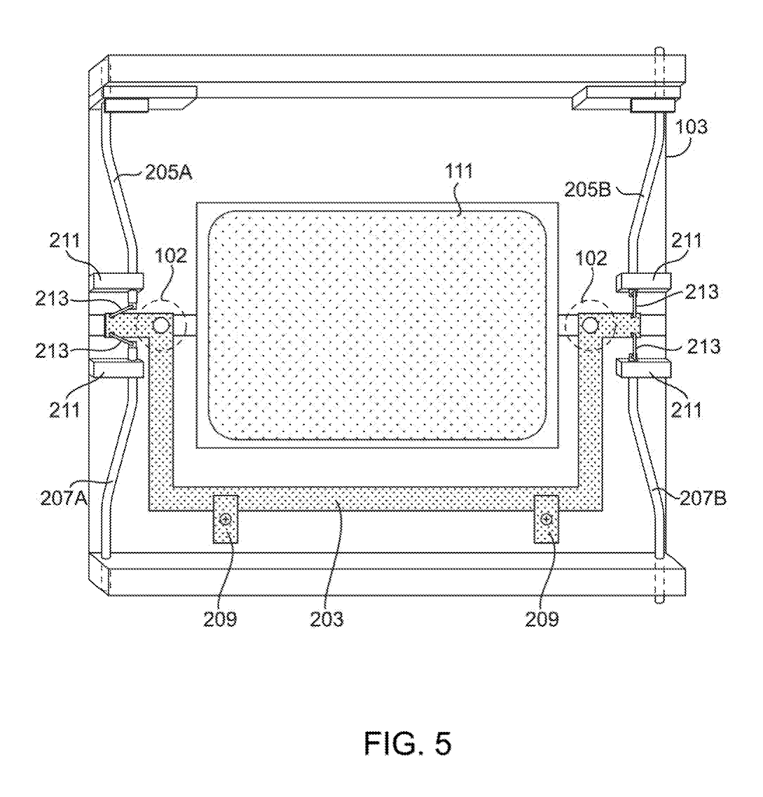

FIG. 5 depicts one embodiment using similar components to FIGS. 3 and 4, but rearranged to accommodate a window 111 in the middle of the door 103. As described elsewhere herein, this is only one way to implement these systems in a door having a window. In the depicted embodiment of FIG. 5, the door 103 includes a window 111, such as a microwave oven door 103. The transfer bar 203, as in FIGS. 3 and 4, causes U-links 213 to project into, or retreat from, receivers in the appliance body. However, because the transfer bar 203 cannot cross the middle of the door 103 without obscuring the window 111, the transfer bar 203 is a generally U-shaped bar 203 configured to circumvent the window 111.

As can be seen in the depicted embodiment of FIG. 5, this change in structure includes a corresponding change in the location of the bracing elements 211 and the guides 209. In the depicted embodiment, the bracing elements 211 do not extend across the body of the door 103, because that would obscure the window 111. Instead, the bracing elements 211 extend partway from the outer edge of the door 103 towards the window 111 to provide a vertical guide for the hinge pins, but stop short of the window 111. Similarly, guides 209 are disposed at the bottom of the door 103 to facilitate lateral movement of the transfer bar.

FIGS. 6A, 6B, and 6C depict an alternative embodiment in which structures similar to FIGS. 3 and 4 are disposed on the exterior of the door 103. In the depicted embodiment, hinge pins 205A, 205B, 207A and 207B are disposed on the exterior of the door 103 and connected to the transfer bar 203 via U-links 213, but the transfer bar 203 and U-links 213 are disposed within an enclosed channel 113 on the exterior of the door 103. Pulls 102 on opposing ends of the transfer bar 203 facilitate lateral movement of the transfer bar 203 and operation of the device. The system of FIGS. 6A, 6B, and 6C otherwise operates in the same manner as that depicted in FIGS. 3 and 4. For example, as can be seen in FIGS. 6A, 6B, and 6C, the distal ends 219 insert into and retract from receivers in the structure of the refrigerator 101. The receivers for hinge pins 207A and 207B may use adjustable seats 407 and chamfers in the same manner described herein with respect to FIG. 3, such as the embodiment depicted in FIG. 4B.

This embodiment has the advantage of an aesthetically pleasing old-world look with exposed hinge pins, which also eliminate moving components from the inside of the door. This allows the entire interior of the door to be insulated, without potentially interfering with the moving parts of the two-way door mechanism.

In an embodiment, the systems and methods for a two-way door include a latching or locking mechanism to prevent the transfer bar 203 from moving while the door 103 is open. This locking means or mechanism operates by inhibiting the “open” set of pins, one or more pins, or all pins, from moving while the door 103 is open, effectively locking the transfer bar 203 in place until the door 103 is closed. FIGS. 7A, 7B and 7C depict an embodiment of a locking system 701. In the depicted embodiment, the locking system 701 comprises a movable element 703 pivotally 705 attached to door 103. The movable element 703 comprises a first element 704 generally in the configuration of a thin rectangular prism perpendicularly attached to a second element 706 also generally in the configuration of a thin rectangular prism. The movable element 703 is attached to the door 103 at a pivot point 705 through the first element 704. In the depicted embodiment of FIGS. 7A, 7B, and 7C, the movable element 703 is attached to the underside of the top edge of the frame 104 at the pivot 705 through the first element 704. At an end of the first element 704, the first element 704 comprises a rounded latch sized and shaped to cooperate with a corresponding notch, groove or channel 702B in the hinge pin 205 or 207 with which the locking system 701 will be used. In the depicted embodiment, the hinge pin notch 702B is disposed at a location near the distal end 219 of the hinge pin 205 or 207, near the point where the hinge pin passes through an aperture in the frame 104 to enter the receiver. The movable element 703 is disposed about the pivot point 705, and the latch 702A is disposed on the movable element 703 at a location such that the movable element 703 can pivot at pivot point 705 to engage the latch 702A of the movable element 703 with the notch 702B of the hinge pin 205 or 207. When the movable element 703 is engaged with the hinge pin 205 or 207, the hinge pin 205 or 207 is inhibited from vertical movement. This in turn inhibits movement of the transfer bar 203 via connection of the hinge pin 205 or 207 to the transfer bar 203 via the corresponding U-link 213.

It is desirable to cause the locking system 701 to engage hinge pin 205 or 207 at the side of the door 103 that is open, and to disengage when the door is closed. Thus, when either end of the door 103 is open, the locking mechanism 701 engages the hinge pin 205 or 207 on the appropriate side while the door 103 is open, and only when the door 103 is closed on both sides, the locking system 701 disengages for both sets of hinge pins 205 and 207.

FIG. 7B depicts the operation of the locking system 701 when the door 103 is closed. In the depicted embodiment of FIG. 7B, the door 103 is closed against the application frame 104. When the door is closed, a movable pin 709 is operated to disengage the movable element 703. The movable pin 709 is disposed perpendicular to the major axis of the hinge pin, such that a proximal end 711 of the movable pin 709 is in contact with the second element 706 of the movable element 703. The opposing distal end 713 of the movable pin 709 is disposed through the door structure to protrude slightly from the back of the door towards the appliance frame 104. When the door is shut, the appliance frame 104 imparts a force on the distal end 713, which pushes the movable pin 709 away from the appliance frame 104 through the door 103. This in turn causes the proximal end 711 to push on the second element 706, causing the movable element 703 to pivot around pivot point 705. This in turn causes the latch 702A to disengage from the hinge pin notch 702B, allowing the hinge pin to move and, by extension, allowing the transfer bar 203 to move.

By contrast, when the door 103 is open, as shown in FIG. 7C, the movable element 703 is subject to a force from a spring 707, which applies a downward force, attempting to engage the movable element 703 with the hinge pin 205 or 207. In the depicted embodiment, the spring 707 is a wire spring but other springs are of course possible. When the door is open, the force imparted by the spring 707 on the end of movable element 703 opposing the end having the latch 702A causes the movable element 703 to rotate at pivot point 705. This in turn causes the latch 702A to engage with the notch 702B in the hinge pin 205 or 207. This effectively locks the hinge pin in place, inhibiting vertical movement of the hinge pin, which in turn inhibits movement of the transfer bar.

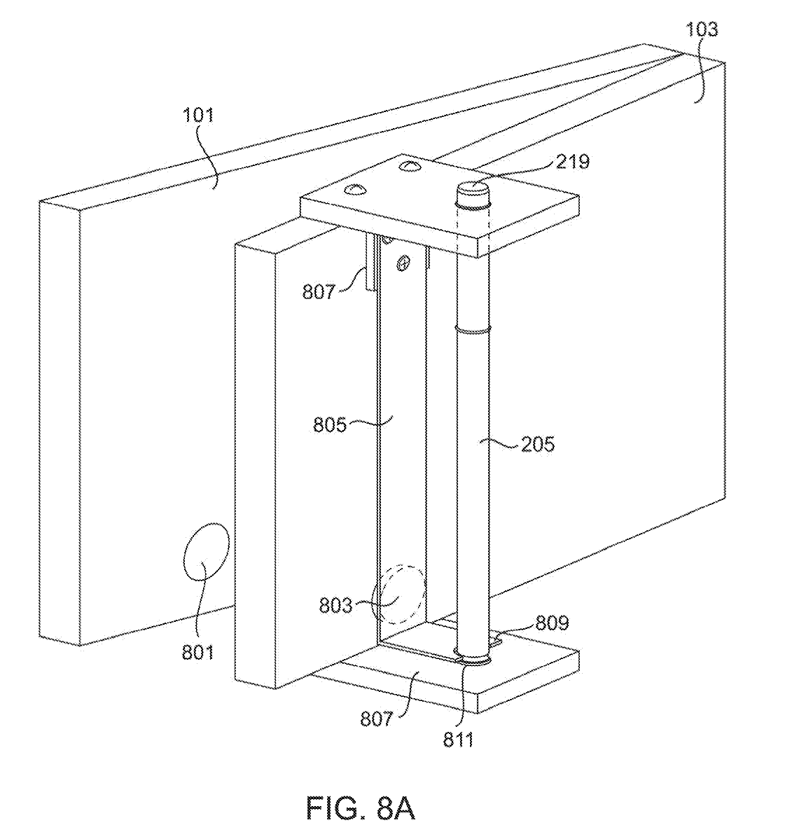

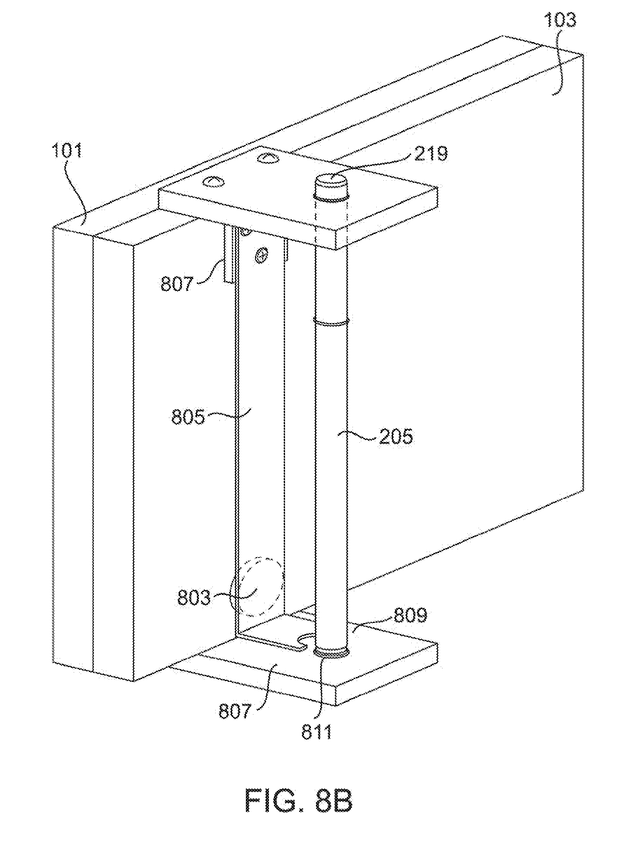

In an alternative embodiment, the locking means may use a magnet. For example, in the depicted embodiment of FIG. 8, the door 103 has a locking mechanism for a hinge pin 205, including a first magnet 801 and a second magnet 803, the two magnets 801 and 803 having opposing polarity such that they attract. The first magnet 801 is disposed in the appliance 101 structure, and the second magnet 803 is disposed in the door 103. The two magnets 801 and 803 are aligned such that when the door 103 is closed, magnets 801 and 803 are close enough that magnetic forces cause them to attract. These locking systems may be used on both or either set of hinge pins, or on the transfer bar.

Depicted magnet 803 is attached to a spring 805. In the depicted embodiment, the spring 805 comprises a spring steel 805. The spring 805 exerts force causing the magnet 803 to move away from the door 103. Attached at the end or bottom of the spring 805 is a latching element 807 having a cutout 809 or latch 809 in the configuration of an arc configured to match a corresponding notch, groove or channel 811 in the hinge pin 205. When the door 103 is open, the opposite magnetic force between magnets 801 and 803 is too weak for magnet 803 to move towards magnet 801. This results in the force of spring 805 pushing latch 807 outward from door 103, such that latch 809 engages with corresponding notch 811 in hinge pin 205, effectively locking the hinge pin 205 in place and inhibiting motion of the hinge pin 205 and, by extension, the transfer bar 203.

However, when door 103 is closed, magnet 803 is attracted to magnet 801 and the magnetic attraction force is stronger than the force of the spring 805. This causes the magnet 803 to move towards the surface of the door 103, caused by the attraction of magnet 801. This in turn causes latching element 807 to retreat from notch 811 in the pin 205, allowing the pin 205 to move vertically, and allowing the transfer bar 203 to move.

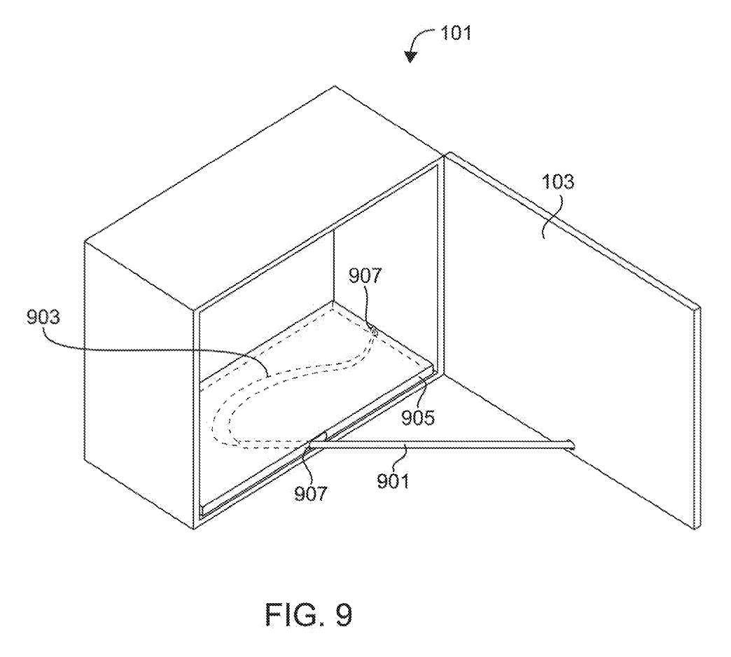

Modern appliances often include electronic or other components in doors, such as water lines, icemakers, or controls. In the prior art, the physical connections for these features is provided at the hinge. However, for a two-way door, this is not possible. In an embodiment of the present systems and methods, an umbilical facilitates a movable line attached to the door. FIG. 9 depicts an embodiment of one such umbilical 901. In the depicted embodiment, an appliance 101 having electronic or liquid lines attached to the door 103 is shown. The lines are run through the umbilical 901. The depicted umbilical 901 is essentially a rigid conduit attached to the inside of the door 103 at the bottom and running to a compartment 905 within the appliance 101. In an embodiment, the conduit may be a telescoping conduit. In the depicted embodiment, the umbilical 901 extends into the compartment 905 far enough that, regardless of how far the door 103 is opened, the end of the umbilical 901 distal from the door 103 remains disposed in the compartment 905. At the distal end of the umbilical 901 from the door 103, the umbilical ends in an opening and the lines 903 are disposed in the compartment 905 with some slack before entering 907 the internal structure of the appliance 101, where they are connected to power, water, or other components as necessary. The slack 903 in the wire facilitates movement with the door 103, while also providing electrical power or water.

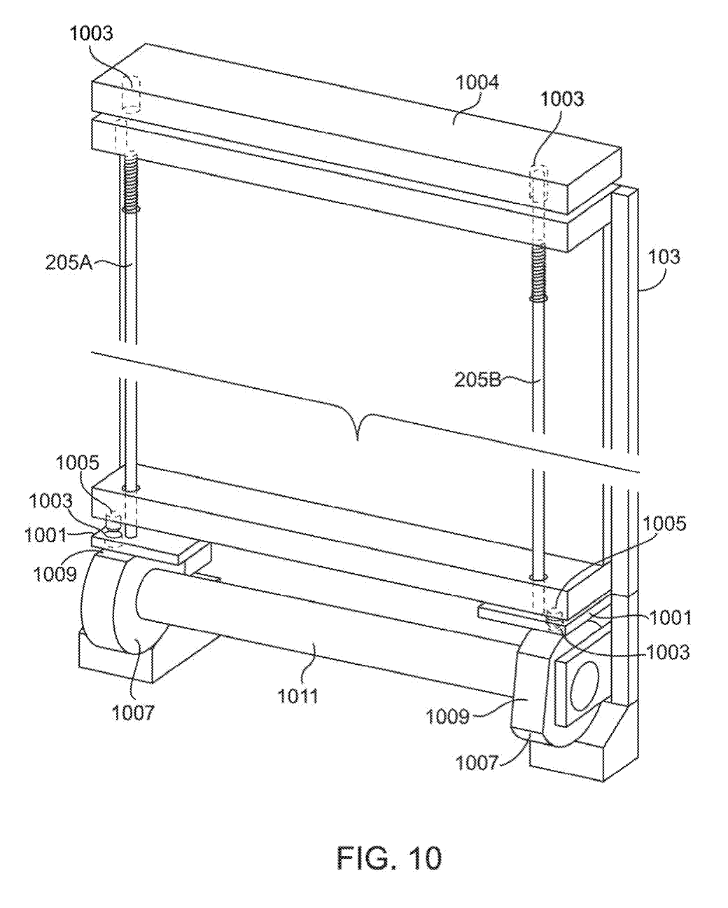

In the depicted embodiment of FIG. 10, an alternative embodiment is shown using only two hinge pins operated by a single mechanism with fewer moving parts. Hinge pins 205A and 205B are vertical pins operated by a pair of spring loaded lifting elements 1001. In the depicted embodiment of FIG. 10, the interior structure of a door 103 is shown. On the left hand side, a lifting element 1001 is spring loaded to apply downward pressure, and a hinge pin 205A has a bottom end resting on the top surface of the lifting element 1001. The depicted lifting element 1001 also comprises a receiver 1003 configured to accept a pin 1005 disposed in the door structure 103. The depicted pin 1005 is disposed on the top surface of the lifting element 1001 proximal to where the bottom of the hinge pin 205A rests on same. In this embodiment, hinge pins 205A and 205B are moved vertically by lifting element 1001 to engage with corresponding receivers 1003 at the top of the appliance structure 1004. However, the bottom of the hinge pins 205A and 205B are not used for rotational motion but rather rest on top of lifting elements 1001, which elevate alternately to cause either hinge pin 205A or 205B to engage the top receivers 1003. The rotating motion is provided on the bottom by stationary pin 1005, which is disposed on the bottom of the door 103 structure and aligned thereon to engage the corresponding receivers 1003 in the lifting element 1001 when the lifting element 1001 is elevated, causing the stationary pin 1005 to enter the receiver 1003. The alternating elevation of the two lifting elements 1001 is provided by a pair of rotating wheels 1007, each having a flattened or cam portion 1009 on a portion thereof, causing each wheel to roughly resemble a flat tire. The wheels 1007 are rigidly attached to each other, by a cross bar 1011 in the depicted embodiment, such that the rotation of either wheel 1007 or the cross bar 1011 causes the rotation of the other wheel 1007 or the cross bar 1011. That is, wheels 1007 and cross bar 1011 rotate in unison. The any of the receivers 1003, particularly the bottom receivers, may have the features shown in FIG. 4B, such as the chamfered top and adjustable seat.

When the cam portion 1009 of each wheel 1007 is facing upward (adjacent to lifting element 1001), the spring force of lifting element 1001 pushes lifting element 1001 downward until it is flush with the cam portion 1009 of the corresponding wheel 1007. This in turn causes stationary pin 1005 to withdraw from the bottom receiver 1003, and causes hinge pin 205A to withdraw from top left receiver 1003. On the opposing wheel, the cam portion 1009 is not axially aligned with that of the other wheel, meaning both cam portion 1009 of both wheels are not simultaneously in contact with corresponding lifting elements 1001. When the round portion of the wheel 1007 is in contact with lifting element 1001, lifting element 1001 is pushed upward, causing receiver 1003 to engage hinge pin 1005 on the right hand side. This elevation of lifting element 1001 likewise pushes hinge pin 205B upward into top right receiver 1003. This effectively provides for a pivoted connection on the right hand side of the door 103, and no connection on the left hand side, allowing the door 103 to be opened on the left.

To reverse the opening, the wheels 1007 and cross bar 1011 are rotated so that the left hand cam portion 1009 is no longer in contact with left lifting element 1001, but the cam portion 1009 of the right wheel 1007 is in contact with the right lifting element 1001. This results in hinge pin 205A projecting into the top receiver 1003 on the left, and stationary pin 1005 engaging bottom left receiver 1003 in left lifting element 1001. On the right, hinge pin 205B drops out of top right receiver 1003, and bottom right receiver 1003 withdraws from right stationary pin 1005. This results in a hinged connection to the left, but an unhinged connection on the right, allowing the door 103 to be opened on the right.

Because the vertical alignment of the pins in this embodiment is not axial (that is, the location of the top and bottom receivers 1003 are not vertically aligned with respect to gravity), the door may be naturally opened or closed by gravity. When configured properly, this can result in a self-closing and/or self-opening door. In the preferred embodiment, the receivers 1003 are configured and positioned such that when the door 103 is opened at an angle less than ninety degrees, the door will close. In an embodiment, the alignment of the top and bottom receivers is configured at least one or both sides to cause the door to self-close when the angle at which the door is open is less than a predetermined angle. In an embodiment, this predetermined angle is about 90 degrees. In another embodiment, this predetermined angle is about 85 degrees. In another embodiment, this predetermined angle is about 80 degrees. In another embodiment, this predetermined angle is about 75 degrees. In another embodiment, this predetermined angle is about 70 degrees. In another embodiment, this predetermined angle is about 65 degrees. In another embodiment, this predetermined angle is about 60 degrees. In another embodiment, this predetermined angle is about 55 degrees. In another embodiment, this predetermined angle is about 50 degrees. In another embodiment, this predetermined angle is about 45 degrees. In another embodiment, this predetermined angle is an angle less than 45 degrees. By contrast, at an angle of greater than ninety degrees open, the door will tend to open, or will be inhibited from closing. In an embodiment, the alignment of the top and bottom receivers is configured at least one or both sides to cause the door to hold open when the angle at which the door is open is more than a predetermined angle. In an embodiment, this predetermined angle is about 90 degrees. In another embodiment, this predetermined angle is about 95 degrees. In another embodiment, this predetermined angle is about 100 degrees. In another embodiment, this predetermined angle is about 105 degrees. In another embodiment, this predetermined angle is about 110 degrees. In another embodiment, this predetermined angle is about 115 degrees. In another embodiment, this predete mined angle is about 120 degrees. In another embodiment, this predetermined angle is about 125 degrees. In another embodiment, this predetermined angle is about 130 degrees. In another embodiment, this predetermined angle is about 135 degrees. In another embodiment, this predetermined angle is an angle more than 135 degrees. In another embodiment, this predetermined angle is about 160 degrees.

It will readily be understood by one of ordinary skill in the art that any number of means are available for transferring the motion of the user grasping a pull (not depicted) to the rotational motion of the wheels 1007 and cross bar 1011, including mechanical transfer means and motorized means. In an alternative embodiment, the transfer bar 203 is motorized. In such an embodiment, a small motor 1101 is disposed within the door 103 and attached to structures that are described herein to effect the movement of the transfer bar 203. This may be preferred in certain embodiments where the strength or dexterity required to physically move the pull is too great, such as due to the load of the door 103. For example, a heavily laden refrigerator door will be supported by the transfer bar, meaning that if manual motion of the hand on the pull is used to move the transfer bar 203, the transfer bar 203 will resist movement based on inertia in proportion to the amount of mass in the door. In other words, heavier doors will be harder to open manually.

To overcome this, a motor 1101 may be provided which provides the energy to move the transfer bar 203, without the user requiring a corresponding amount of manual force using the hand. The use of a motor also allows for a wider variety of sizes and shapes of pulls because the motion of the pull does not necessarily have to correspond to the motion of the transfer bar. For example, a stationary pull may be used that simply detects the presence of a hand to actuate the transfer bar 203.

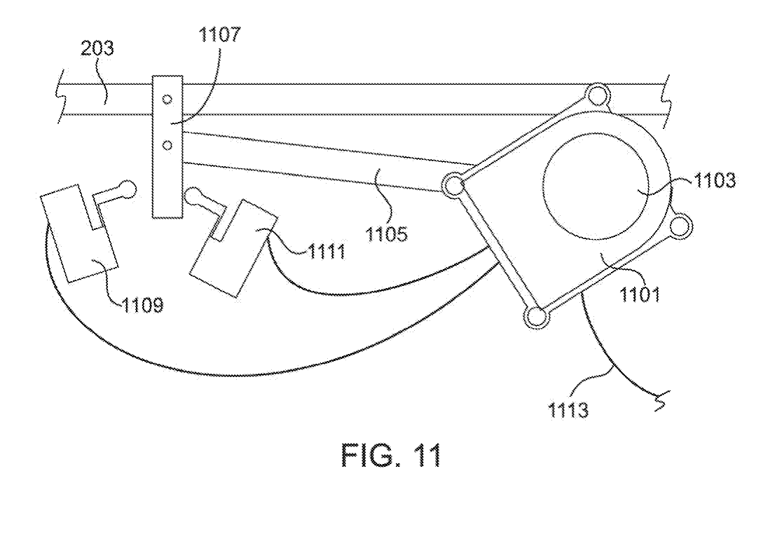

FIG. 11 depicts an embodiment of a two-way door using a motor 1101 as the force to operate the transfer bar 203. For simplicity sake, FIG. 11 depicts the transfer bar 203 in isolation with the motorized components, and omits the U-links and hinge pins, which otherwise operate in the same fashion as already described herein. As can be seen in FIG. 11, this embodiment depicts a motor 1101 having a rotating element 1103 with a drive bar 1105 pivotally attached to the rotating element 1103, and pivotally attached to a vertical bar 1107. The vertical bar 1107 is in turn rigidly attached to the transfer bar 203. The motor 1101 is also an electrical communication with two sensors 1109 and 1111, each of which are disposed to be contacted by vertical bar 1107 during traverse. When a signal is received by the motor 1101 to open the door, the motor 1101 operates, and the rotational motion of the rotational element 1103 drives drive bar 1105 left or right. The rotational motion of the motor 1101 thus pushes the transfer bar 203 to the left or the right. When the transfer bar 203 is moved far enough to the left, the vertical bar 1107 contacts sensor 1109, which sends a signal to motor 1101 to stop. This is the maximum leftward extent of transfer bar 203, similar to opening the door 103 from the right hand side.

Conversely, if the opposite signal is received, motor 1101 operates in the opposite direction, causing rotational element 1103 to draw a drive bar 1105 to the right. This in turn pulls vertical bar 1107 and transfer bar 203 to the right, until vertical bar 1107 contacts sensor 1111, which signals motor 1101 to stop. This rightward position is the equivalent of manual operation of the transfer bar 203 by a pull, and corresponds to the door being hinged on the right hand side, and opened on the left.

As will be clear to one of ordinary skill in the art, any number of pulls 102 or other actuating means may be provided to communicate with the motor 1101 and cause it to begin or end movement. Alternatively, the motor 1101 may be configured to simply begin motion in whichever direction is available. That is, if the motor 1101 senses that sensor 1111 has been triggered, and any indication to move is received, the motor 1101 will rotate until sensor 1109 is triggered, and vice versa. This system may be implemented in connection any of the illustrative embodiments described herein. Electrical power 1113 may be supplied via an umbilical 901 as described elsewhere herein, or may be supplied via corresponding contact points on the appliance frame and the door. In the latter case, when the door is open, there may not be electrical power to the motor 1101, and thus the transfer bar 203 does not move and there is lessened risk of accidentally triggering the motor and causing the door 103 to fall off the appliance.

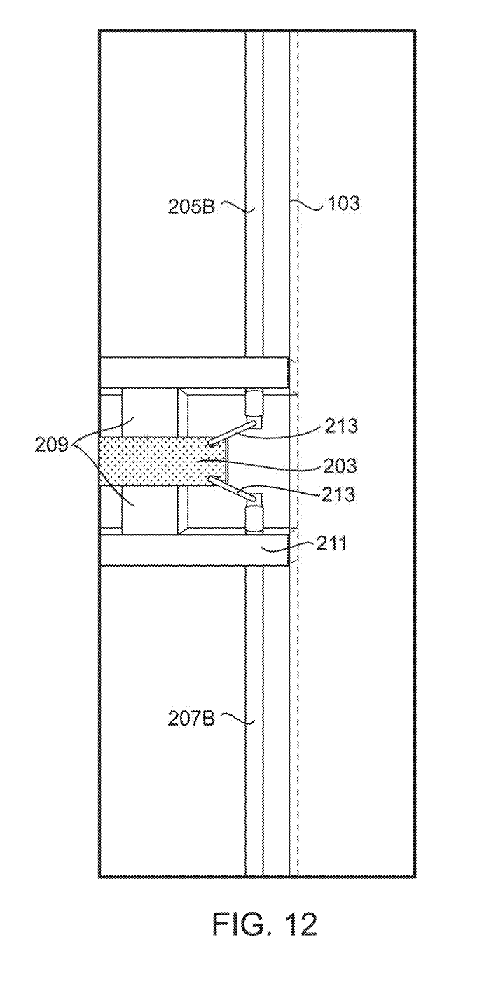

It should be noted that with respect to in particular FIGS. 3, 4 and 5, the pulling force of the U-links 213 is provided by the U-links being disposed to the outside of the transfer bar 203. However, it will be clear to one of ordinary skill in the art that this is only one option, and that other possibilities exist. For example, the force could be provided by the transfer bar 203 moving in the opposite direction and the U-links laying against the top of the transfer bar 203. For example, in FIG. 12, the hinge pins are actuated by moving the transfer bar 203 to the left. Thus, it would be clear to one of ordinary skill in the art that the desired motion of the pull 102 can be adjusted leftward or rightward for the opening action depending upon the preferences of the manufacturer.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A system for opening a door from either side comprising:
a door structure having a top side and an opposing bottom side, and a left side and an opposing right side;
a transfer bar having a first end and an opposing second end;
a first pair of hinge pins, each hinge pin in said first pair of hinge pins having a proximal end connected to said first end of said transfer bar and an opposing distal end, said distal end of a first hinge pin in said pair disposed at said top side and said distal end of a second hinge pin in said pair disposed at said bottom side;
a second pair of hinge pins, each hinge pin in said second pair of hinge pins having a proximal end connected to said second end of said transfer bar and an opposing distal end, said distal end of a first hinge pin in said second pair disposed at said top side and said distal end of a second hinge pin in said second pair disposed at said bottom side;
wherein when said transfer bar moves laterally toward said left side, said transfer bar causes said distal ends of said first pair of hinge pins to protrude outward from said top and bottom sides of said door, and said distal ends of said second pair of hinge pins to retreat within said door structure.

2. The system of claim 1, wherein each hinge pin in said first pair and second pair of hinge pins is connected to said transfer bar via a U-link rotatably connected to said proximal ends and rotatably connected to said transfer bar.

3. The system of claim 1, wherein said transfer bar and said hinge pins are disposed within the interior structure of said door structure.

4. The system of claim 1, wherein said transfer bar and said hinge pins are disposed on an exterior surface of said door structure.

5. The system of claim 4, wherein said door structure is attached to an appliance.

6. The system of claim 5, wherein said appliance comprises a utility connection line and said utility connection line is connected to said door structure through an umbilical extending from an interior side of said door to a compartment within said appliance, said umbilical configured such that when said door is opened to a maximum angle, the distal end of said umbilical remains in said compartment.

7. The system of claim 5, wherein when said transfer bar moves laterally toward said left side and causes said distal ends of said first pair of hinge pins to protrude outward from said top and bottom sides of said door, said distal ends of said hinge pins engage corresponding receivers in said appliance such that said door structure is rotatable on said first pair of hinge pins.

8. The system of claim 1, wherein said distal ends of each of said hinge pins in said first pair and said second pair are chamfered.

9. The system of claim 1, wherein when said transfer bar moves laterally toward said right side, said transfer bar causes said distal ends of said second pair of hinge pins to protrude outward from said top and bottom sides of said door, and said distal ends of said first pair of hinge pins to retreat within said door structure.

10. The system of claim 1, wherein said top hinge pin in said first pair and said top hinge pin in said second pair are disposed through a locking mechanism.

11. The system of claim 10, wherein said each of said locking mechanisms comprises a movable latch configured to rotatably engage a corresponding circumferential notch in said each of said top hinge pins in said first pair and said second pair.

12. The system of claim 1, wherein said transfer bar is moved by manipulating hand pulls attached to said transfer bar.

13. The system of claim 1, wherein said transfer bar is moved by a motor attached to said transfer bar.

14. A system for opening a door from either side comprising:
an appliance comprising an appliance body and a door, said door having a top portion and an opposing bottom portion, and a left side and an opposing right side;
a first top receiver disposed in said appliance body at said left side;
a first through bore in said top portion axially aligned with said first top receiver when said door is closed;
a second top receiver disposed in said appliance body at said right side;
a second through bore in said top portion axially aligned with said second top receiver when said door is closed;
a first through bore in said bottom portion axially aligned with said first through bore in said top portion;
a second through bore in said bottom portion axially aligned with said second through bore in said top portion;
a first wheel having a first camming portion disposed at a position thereon;
a second wheel having a second camming portion disposed at a position thereon;
a crossbar axially connecting said first wheel to said second wheel such that said crossbar, first wheel, and second wheel move in unison;
a first lifting element between said first wheel and said bottom portion of said door, said first lifting element having a first bottom stationary hinge pin axially aligned with a first receiver in said bottom portion;
a second lifting element between said second wheel and said bottom portion of said door, said second lifting element having a second bottom stationary hinge pin axially aligned with a second receiver in said bottom portion;
a first hinge pin having a bottom end and an opposing top end and disposed through said first top bore and said first bottom bore such that said bottom end rests on said first lifting element;
a second hinge pin having a bottom end and an opposing top end and disposed through said second top bore and said second bottom bore such that said bottom end rests on said second lifting element;
wherein when said first wheel is rotated such that said first camming portion is generally coplanar with the bottom of said first lifting element:
said first bottom stationary hinge pin retreats from said first bottom receiver and said top end of said first hinge pin retreats from said first top receiver; and
said second camming surface is not adjacent to said second lifting surface such that said second lifting surface forms a tangent line to a rounded portion of said second wheel and said rounded portion of said second wheel lifts said second lifting element such that said second bottom stationary hinge pin engages said second bottom receiver and said top end of said second hinge pin engages said second top receiver such that said door is pivotable on an axis of rotation from said second top receiver to said second bottom receiver.

15. The system of claim 12:
wherein when said second wheel is rotated such that said second camming portion is generally coplanar with the bottom of said second lifting element:
said second bottom stationary hinge pin retreats from said second bottom receiver and said top end of said second hinge pin retreats from said second top receiver; and
said first camming surface is not adjacent to said first lifting surface such that said first lifting surface forms a tangent line to a rounded portion of said first wheel and said rounded portion of said first wheel lifts said first lifting element such that said first bottom stationary hinge pin engages said first bottom receiver and said top end of first hinge pin engages said first top receiver such that said door is pivotable on an axis of rotation from said first top receiver to said first bottom receiver.

16. The system of claim 12, wherein said axis of rotation has an angle offset from an alignment normal to the pull of gravity.

17. The system of claim 14, wherein said offset is configured so as to cause gravity to pull said door closed when said door is open at an angle of less than 90 degrees.

18. The system of claim 14, wherein said offset is configured so as to cause gravity to pull said door open when said door is open at an angle of greater than 90 degrees.

19. The system of claim 12, wherein said first hinge pin is spring-loaded against the bottom of said top portion, and said second hinge pin is spring-loaded against the bottom of said top portion.

20. The system of claim 12, wherein said appliance comprises a utility connection line and said utility connection line is connected to said door through an umbilical extending from an interior side of said door to a compartment within said appliance, said umbilical configured such that when said door is opened to a maximum angle, the distal end of said umbilical remains in said compartment.
